(19) United States
(12) Patent Application Publication
(10) Pub. No.: US 2009/0198593 A1
(43) Pub. Date: Aug. 6, 2009

(54) Method and apparatus for comparing entities

(75) Inventors: Karl Klug, Miesbach (DE); Michal Skubacz, Grobenzell (DE); Peter Suda, Munchen (DE); Jurgen Tolzke, Poing (DE); Cai-Nicolas Ziegler, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS ENTERPRISE COMMUNICATIONS GmbH CO.KG

(21) Appl. No.: 12/012,181

(22) Filed: Jan. 31, 2008

(51) Int. Cl. G06Q 30/00

(52) U.S. Cl. 705/27

(57) ABSTRACT

A method and apparatus for comparing entities, such as companies or trademarks, based on available pricing and feature information regarding goods or services provided by the companies. Web services, e.g. price finding robots, are employed to obtain pricing and feature information for similar products from different companies. Products having similar features but derive from different companies can be grouped to clusters and be analyzed with respect to average pricing levels. Data formats for pricing and feature information stemming from different web services may be automatically retrieved and mapped into a common format. The method allows to evaluate systematic deviations in the company's pricing policies or to detect if companies do not have a matching product portfolio. One can also estimate the prestige or acceptance of a company or brand as a function of prices tolerated by the underlying market. This may facilitate marketing strategies.

### FIELD OF THE INVENTION

The invention relates to methods and apparatuses that allow to compare entities, as for example companies or trademarks, that provide goods or services. Relevant information or data on the companies and their products is retrieved from an information space, as for example the internet, in an automatic fashion.

### BACKGROUND OF THE INVENTION

For example, for marketing reasons a comparison between given companies operating in the same business area is desirable. However, due to the vast and generally unstructured information this is not easy to achieve. Conventionally, marketing analysts have to browse available information sources, for example mailing catalogs, retail stores or also internet web shops. In the marketing business a manual analysis of competitors' profiles and prizing strategies is then necessary. As a result, often questions should be answered like which products X of company A correspond to products Y of the portfolio of company B? It can also be interesting to know which products or product groups of company A significantly deviate from the pricing structure of company B's corresponding products.

Conventionally, the necessary information collection and analysis is performed in a manual fashion. This requires a considerable human effort, as for example in terms of traditional market research collection has to be done through polling customers or pear group members. Also analysis for marketing purposes has been achieved so far in a very low-tech fashion. This requires human operators for aggregating the relevant information and for finding corresponding products of different makes and evaluating the pricing information.

### SUMMARY OF THE INVENTION

This disclosure presents methods and apparatuses for comparing entities that provide goods or services as products. Specifically, entity identifiers are set for each entity, and a product category is set for defining classes of goods or services provided by said entities. Then, query results are obtained by querying at least one web service, wherein the web service provides predetermined product parameters as characteristic information on the products of the product category as a function of the entity identifier. One can then map, for example, product parameters from said web service to a predetermined data format for said product parameters which enables to further process the aggregated information.

For example, the method can be employed for comparing companies based on available product pricing information. Then, a product category can be selected, said product category comprising a plurality of products. For comparing companies pricing and product feature parameters for products of said selected product category is retrieved. This is for instance done by a price finding robot, said price finding robot providing said pricing and product feature parameters for products as a function of a company name. Then, products having similar product feature parameters and stemming from different companies are detected, and a difference in pricing features of those products is calculated.

This strategy allows to group products that have similar features but derive from different companies. One can then form clusters of products. An analysis with respect to average pricing levels in the groups or clusters is then feasible.

Hence, data formats for pricing and feature information stemming from different web services may also be automatically retrieved and mapped into a common format. The method allows to evaluate systematic deviations in the companies' pricing policies or to detect if companies do not have a matching product portfolio.

This disclosure also describes an apparatus that may be implemented to carry out such a method for comparing entities. In one embodiment an apparatus comprises an input means for setting entity identifiers and at least one product category identifier. The apparatus comprises a processing platform which is communicatively coupled to the internet for querying at least one web service for retrieving predetermined product parameters as characteristic information on the products of the product category. This information is obtained as a function of the entity identifier as a query result. The processing platform may also map said product parameters to a predetermined data format for said product parameters. For example, a similar apparatus can be implemented as a computer. Additionally, a computer program may be implemented based on one of the above aspects of a method for comparing entities to initiate an execution of such a method on a computer.

### BRIEF DESCRIPTION OF THE DRAWINGS

In the following aspects and embodiments of the invention are described with reference to the figures in the drawings.

FIG. 1 shows an embodiment of an apparatus for comparing companies based on product information on the internet;

FIG. 2 shows an exemplary flow chart for a method for comparing entities;

FIG. 3 shows exemplary data formats and mapping functions for information retrieved from a prize finding robot;

FIG. 4 shows an exemplary mapping between sets of products deriving from different companies; and

FIG. 5 shows an exemplary diagram for grouping similar products into clusters.

### DETAILED DESCRIPTION OF EMBODIMENTS OF THE INVENTION

In the following embodiments of the method and apparatus for comparing entities according to the present invention are described with reference to the enclosed figures.

An embodiment of the invention, for example, can be employed when two companies are given that operate in the same or similar business. For example, those companies may offer tangible products, as for example digital cameras. However, a comparison can be performed also between companies providing services having, for example, trade names. The following aspects and embodiments take advantage of the information offered in the internet, as for example, through price finding robots as a middle layer for data acquisition. Hence, this framework operates in an automatic manner and is therefore extremely cost efficient. Additionally, state of the art information retrieval and text mining techniques can be included.

Price finding robots provide information on a variety of products together with specific product parameters. As one dedicated product parameter the price or market prize of such a product can be obtained from a price finding robot.

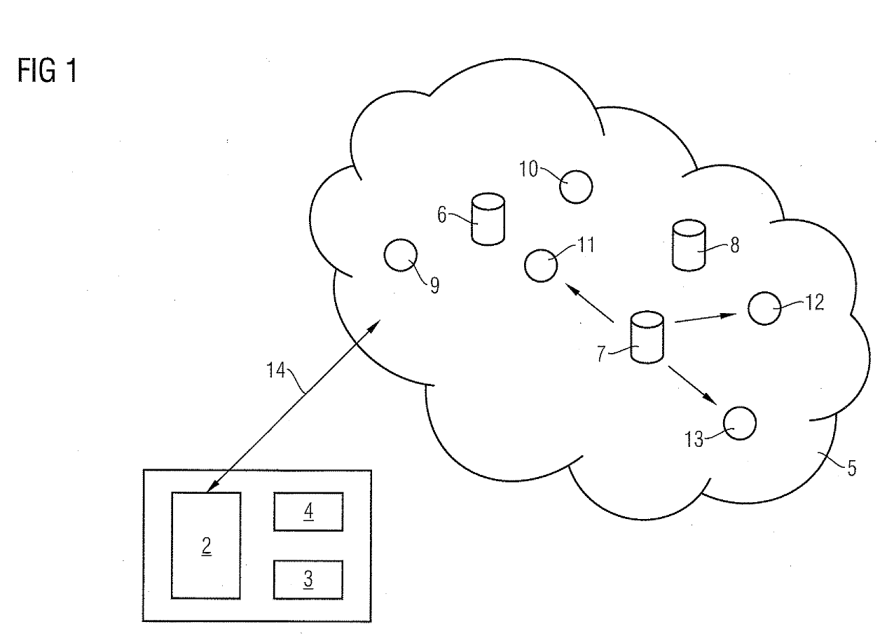

FIG. 1 shows one embodiment of an apparatus for comparing entities, such as companies or company names, trademarks or other labels associated to certain entities. The apparatus 1 comprises a processing platform 2, a user interface 3 and a display 4. The processing platform 2 is for example a PC implemented to perform a method for comparing entities as explicated below. The processing platform is connectively coupled to the internet 5 which is shown through the arrow 14.

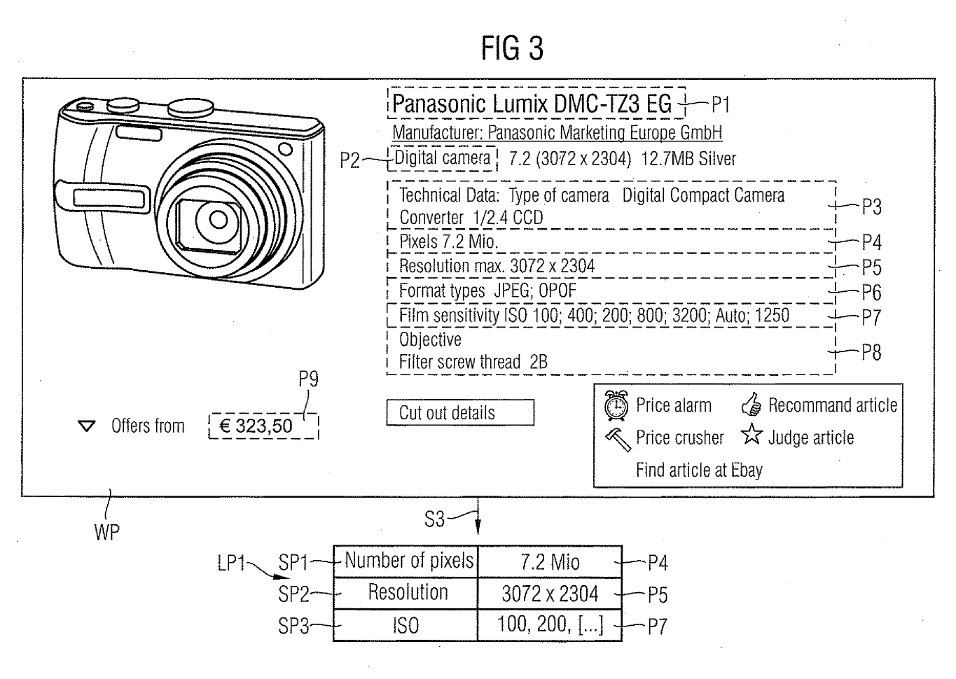

The internet 5 among other elements comprises a plurality of web services and in particular price finding robots 6, 7, 8. Price finding robots search for products and their respective prices, for example, in online shops of the internet 5. For example, the price finding robot 7 browses online shops 11, 12, 13 and provides information on a product including usually the lowest available price. For example, FIG. 3 shows a typical data format or web page provided by a price finding robot. A variety of price finding robots are known wherein only as an example German robots “Preisroboter” (http://www.preisroboter.de), “Günstiger” (http://www.guenstiger.de) and “Idealo” (http://www.idealo.de) are mentioned.

This abundant information on products and prices available on the internet or World Wide Web is used for estimating and comparing companies providing those products. Through querying the price finding robots the pricing structure, offer and demand regarding certain products or services can be extracted. Such price finder robots are particularly suited to track parameters regarding retail products, as for example digital cameras. However, also other products or web services can be monitored or employed. For example, internet book shops provide pricing and further information on certain authors and the prizes of their books, titles, number of editors and so forth.

The processing platform 2 of the apparatus 1 shown in FIG. 1 is adapted to query those web services or price finder robots, respectively.

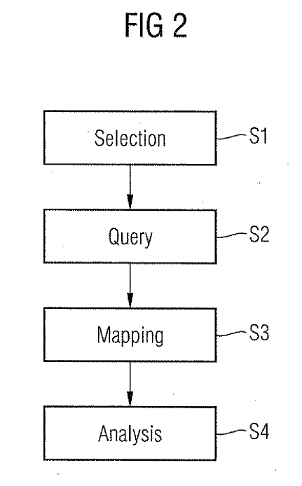

FIG. 2 shows an exemplary flow chart for a method for comparing entities that can be implemented, for example, as a computer program. The corresponding computer program may then initiate the execution of such a method on a processing platform as shown in FIG. 1.

In step S1 an entity identifier and a product category for comparison is selected. An entity identifier is, for example, a company name, a make, a trademark name, a brand name, but may be also a person's or party's name. Recalling the example of digital cameras an entity identifier can be, for example, the make “Canon”, “Fuji” or “Panasonic”. The product category, for example, can be defined as “digital cameras”.

Next, in step S2 the processing platform as shown in FIG. 1 submits queries to the web services, i.e. price finding robots. As a result of this query in step S2 a plurality of product feature pages according to the entity identifier, for example “Fuji”, “Panasonic”, “Canon” and a category identifier such as “digital cameras” is obtained. For example, the upper part of FIG. 3 shows a typical query result. The query result WP discloses a variety of product parameters P1-P9.

For example by selecting only price finder robots from a given country a cross company comparison by means of product pricing can be performed on a fine grained level. This means on a country level, regional or world wide level comparisons are feasible.

For example, product parameter P1 relates to the make “Panasonic” plus the type “Lumix DMC-TZ3 EG”. Product parameter P2 reflects the product category “digital camera”. Product parameters P3-P8 correspond to technical features of the digital camera proposed in the query result WP. For example, P4 states the number of pixels, P5 the resolution, P6 supported data format types, P7 the sensitivity and P8 the diameter of the filter screw thread. Product parameter P9 relates to the available price of the product.

The processing platform 2 is, for example, implemented with an HTML-file wrapper that extracts the textual information from the fields containing the product parameters P1-P9 from the web page WP. Such wrappers can be adapted to specific price finder robots or their proprietary data format in which the products are presented in the query results WP, i.e. the information retrieval from the query results WP is executed through dedicated language wrappers. Language or HTML-wrappers are known in the art.

In FIG. 2 the next step S3 comprises mapping, the retrieved raw data or product parameters P1-P9 into a data format for further processing. This is illustrated in FIG. 3 as arrow S3. As a result, a list LP1 is provided, the list having standard denominators SP1, SP2, SP3 for example for the number of pixels (SP1), the resolution (SP2) and the sensitivity (SP3). The extracted product parameters P4, P5, P6 are mapped to those standard denominators SP1, SP2, SP3. Since the method steps S1-S3 can be carried out for a plurality of price finding robots or product categories it may be also desirable to convert proprietary formats for the product parameters from different price finding robots. Therefore, the mapping step S3 may also comprise a mapping of product parameters extracted from different price finding robots to a standard list as shown as LP1 in FIG. 3.

Product parameters or features of products may also vary across price finding robot platforms. For example, the same feature “number of mega pixels” can be labeled as “resolution” or “effective points”. Hence, the mapping step S3 optionally also includes an assignment of the product parameters corresponding to the same semantic feature to the same standard denomination. Such mapping functions can be implemented manually by specifying specific mapping rules. Once, those mapping rules are established the mapping of the specific product features or product parameters from different price finding robots can be done automatically. As a result of the mapping step S3 product data for each model or make is acquired. Hence, data structures containing the structured information on products belonging to different companies or makes are provided.

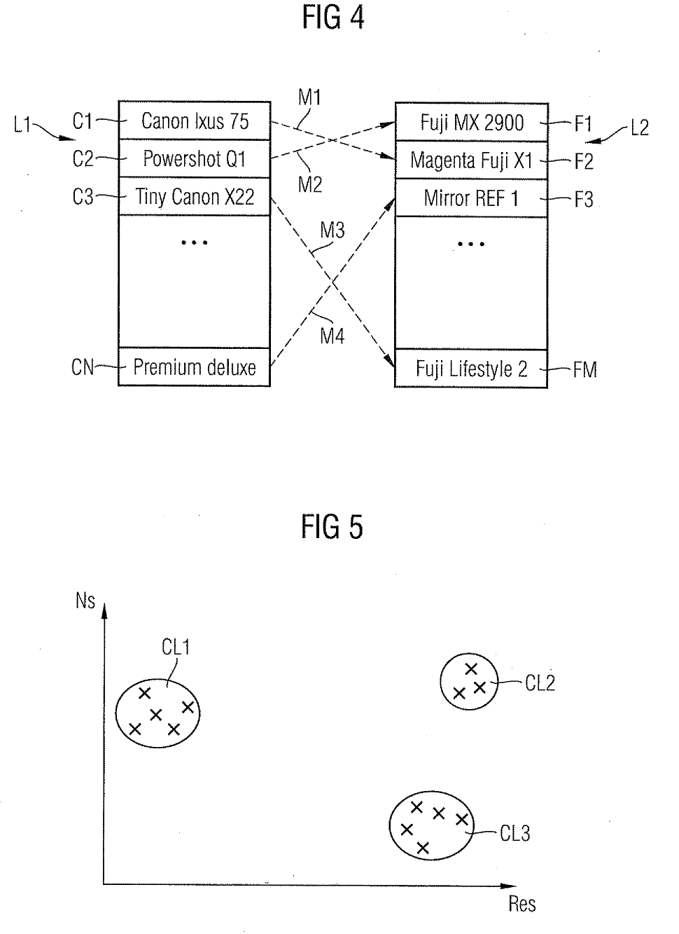

FIG. 4 shows two exemplary lists L1, L2 that include data structures corresponding to digital cameras provided by two digital camera makers. The entries of the lists L1, L2 correspond to the camera name as one exemplary representative product parameter. Further product parameters are tagged to the representative parameter. In an analysis step S4 as shown in FIG. 2 corresponding products of different makes are computed. This can be done as a function of the product features represented by the product parameters for each entry C1-CN and F1-FM. For example, for each product of one brand (for example list L1) a corresponding product in the list L2 is searched for. For example, one can apply similarity functions that operate on the basis of the features supported by the product parameters. For example, each entry or data structure C1-CN has associated product parameters, for example, the ones shown in FIG. 3 with respect to LP1.

The product parameters, for example, for entry or data structure C1 can be regarded as a three-dimensional vector. Analogously, all entries in the lists L1, L2 can be represented by three-dimensional vectors. A similarity measure, for example, can be the metric difference between those parameter vectors for each entry C1-CN, F1-FM. As a result, one obtains a mapping of entries in the list L1 to entries in the list L2. One can also contemplate other similarity measures such as cosine similarities or Pearson correlations.

For example, the product C1=“Canon Ixus 37” corresponds best to the product F2=“Magenta Fuji X1”. This is indicated by a mapping arrow M1. Similarly, mappings between C2 and F1 (M2), C3 and Fn (M3) and Cn and F3 (M4) can be established. Certainly, other differing similarity functions or measures can be implemented. As a result, a bipartite match making of products from the two lists L1 and L2 is obtained.

Now, an analysis in step S4 as illustrated in FIG. 2 is carried out. It is, for example, possible from the extracted product data including prices to make a statement on the pricing structure for similar or mapped products from different companies. For example, an average of the pricing difference for similar or same products can be calculated. A finding of such comparison could be for example that a high-price mirror reflex camera of the make “Fuji” is on average 30% more expensive than a counter part camera by “Canon”. On the other hand, an analysis can recover that “Panasonic”-low-cost cameras, i.e. digital cameras having product parameters corresponding to low-cost, for example low-resolution cameras, are significantly cheaper than the respective cameras of the make Canon. Hence, in the analysis step S4 relevant marketing data is obtained. In eventual steps carried out, for example, by marketing analysts, one may investigate why this difference is the case. The reason can be based on particular high quality products of one firm, or the reputation or brand value among consumers.

In an alternative or optional analysis step a portfolio gap analysis can be performed based on the acquired data. For example, if no match can be found as illustrated in FIG. 4, it is recognized that certain products having specific product parameters are available from one company but not from another.

According to another aspect of a method for comparing companies based on their products available on the internet, the analysis can be extended to grouping certain products. For example, products having similar but not like product parameters sets are clustered into product groups. For example, one product group with respect to digital cameras could be lower budget cameras opposed to high end mirror reflex cameras. Then, average prizes for these clusters or products belonging to a cluster are aggregated and compared on a per-cluster rather than on a product basis.

A variety of clustering methods are available, as for example k-means, expectation maximization, density-based clustering etc. FIG. 5 shows an exemplary diagram for cluster building for products. The X-axis, for example, shows the resolution of digital cameras and the Y-axis corresponds to the product feature of “noise”. Crosses indicate digital cameras having the respective combination of noise and resolution. One may now define clusters in this two-dimensional parameter space which is spanned up by the resolution and the noise. Certainly, other product parameters can be used for clustering.

For example, the cluster CL1 refers to a plurality of digital cameras having a low resolution and high noise. This would correspond to cheap consumer low budget cameras. On the other hand, cluster CL3 may refer to high-end digital cameras with a high resolution and low noise levels. Another exemplary cluster is shown as CL2 in the diagram of FIG. 5.

Instead of matching single products from different companies or makes, now clusters with average prices can be compared to each other. Clustering allows also an overall portfolio gap analysis with respect to companies or producers. For example, one may detect that a certain make, say “Fuji”, does not offer cameras that can be classified into cluster CL2.

Finally, significant deviations in prices of corresponding products or products of different companies belonging to same clusters can be computed. This leads to a cross company comparison for the products. In particular, the pricing information may be relevant for marketing issues. In a display as shown in FIG. 1 of the apparatus 1, strong deviations in pricing, i.e. large differences of prices for a same or similar product but from different companies are indicated by brightly colored graphs. A variety of display modes may be contemplated.

An exemplary overall score could summarize individual scores or differences between pricing policies. For example, as a result of the analysis, one may find that cameras by the make “Canon” appear to be 30% more expensive than comparable products by the brand “Fuji”. Regarding marketing issues this might indicate that Fuji's customers are willing to pay a premium for the higher quality products or a more prestigious brand name.

Hence, the several contemplated aspects and embodiments of the invention provide for an automatic price based comparison of companies, in particular, for business to customer products. The overall framework either implemented as a computer program or apparatus, for example computer, carries out the relevant method and analysis steps for the price based comparison. Additionally, the user may input similarity measures to find corresponding products in an automatic fashion. For example, product or service A of company B is comparable to product or service C of make D. Further, the application allows to compare single products but also to compare product groups or clusters by a way of applying standard clustering techniques on parameter features that are extracted from the product descriptions from web service query results. Additionally, portfolio gap analyses may be carried out. The above mentioned aspects and embodiments may specifically enhance and facilitate the strategies of marketing analysts.

1. A method for comparing entities providing goods or services as products comprising:
setting an entity identifier for each entity;
setting a product category for defining goods or services provided by said entities;
querying at least one web service, said web service providing predetermined product parameters as characteristic information on the products of the product category as a function of the entity identifier as a query result; and
mapping product parameters from said web service to a predetermined data format for said product parameters.

2. The method of claim 1, wherein said entity identifier is at least one of the group of a company name, a make, a trademark name, a brand name or a person's name.

3. The method of claim 1, further comprising:
providing a product category identifier according to said product category.

4. The method of claim 3, wherein the product category identifier is at least one of the group of a product or service label, a brand name, a trademark, or a title.

5. The method of claim 3, wherein querying comprises:
submitting at least one entity identifier and a product category identifier to said web service.

6. The method of claim 1, wherein said web service is a price finding robot.

7. The method of claim 6, further comprising:
selecting a price finding robot from a plurality of price finding robots.

8. The method of claim 1, wherein said predetermined product parameters comprise at least a product identifier and pricing information.

9. The method of claim 1, further comprising:
extracting said product parameters from said query result, wherein said product parameters are obtained in a proprietary web service format.

10. The method of claim 9, wherein extracting comprises running an HTML-wrapper on the query result.

11. The method of claim 9, further comprising:
reformatting said predetermined product parameters from a proprietary format into a predetermined data format.

12. The method of claim 1, wherein each predetermined product parameter is associated to a web service specific product identifier.

13. The method of claim 12, wherein querying comprises submitting a query to at least a first web service and a second web service; and
mapping comprises associating a web service specific product identifier of the first web service to a web service specific product identifier of the second web service, said web service specific identifiers corresponding to the same product parameter.

14. The method of claim 13, further comprising:
comparing product parameters for a product of a first entity with product parameters for a product of a second entity for obtaining corresponding products of the first and second entity.

15. The method of claim 14, wherein comparing comprises calculating a similarity measure between product parameters for said product of the first entity with product parameters for said product of the second entity.

16. The method of claim 1, wherein said web service provides sets of product parameters for products being associated to a product and being provided by an entity, said set of product parameters including pricing information on the product.

17. The method of claim 16, further comprising:
calculating a similarity measures between a set of product parameters being associated to products of a first entity and a set of product parameters being associated to products of a second entity.

18. The method of claim 1, further comprising:
for each entity, clustering products having similar product parameters into a product cluster;
calculating at least one product parameter average over a product parameters of products being clustered into one product cluster; and
comparing a product parameter average of a first cluster with a product parameter average of a second cluster.

19. The method of claim 18, further comprising:
selecting a product cluster of a first entity; and
searching for a similar or same product cluster of a second entity.

20. A method for comparing companies based on available-product pricing information comprising:
selecting a product category comprising a plurality of products;
retrieving pricing and product feature parameters for products of said selected product category utilizing a price finding robot, said price finding robot providing said pricing and product feature parameters for products as a function of a company name;
detecting products having similar product feature parameters and stemming from different companies; and
calculating a difference in pricing features of products having similar product feature parameters and stemming from different companies.

21. The method of claim 20, wherein said method steps are carried out for a plurality of product categories.

22. The method of claim 20, further comprising:
for each product category, calculating an average difference in pricing of products having similar product feature parameters and stemming from different companies.

23. An apparatus for comparing entities providing goods or services comprising:
an input means for setting entity identifiers and at least one product category identifier;
a processing platform communicatively coupled to the internet for querying at least one web service for retrieving predetermined product parameters as characteristic information on the products of the product category as a function of the entity identifier as a query result; and for mapping said product parameters to a predetermined data format for said product parameters.

24. The apparatus of claim 23, wherein said apparatus is a computer.

25. A computer program product being implemented to initiate an execution of the method of claim 1 on a computer.
